(19) United States
(12) Patent Application Publication
(10) Pub. No.: US 2007/0220153 A1
(43) Pub. Date: Sep. 20, 2007

(54) Wireless traffic prioritization

(76) Inventor: Satish Kumar Veerapuneni, Hillsboro, OR (US)

Correspondence Address: LeMoine Patent Services, PLLC;C/O PortfolioIP, P.O. Box 52050, Minneapolis, MN, 55402, US

(21) Appl. No.: 11/378,099

(22) Filed: Mar. 17, 2006

(51) Int. Cl. G06F 15/16

(52) U.S. Cl. 709/227; 709/228

(57) ABSTRACT

Packets to be transmitted in a wireless communication system are prioritized based on a time parameter associated with the packets.

### FIELD

The present invention relates generally to communications networks, and more specifically to wireless networks.

### BACKGROUND

Wireless networks allow electronic devices to communicate without being cabled together. For example, using wireless networks, laptop computers may be able to communicate with other computers while mobile. Wireless networks may operate in compliance with network standards such as Institute of Electrical and Electronics Engineers (IEEE) 802.11 standards and IEEE 802.16 standards.

Network nodes in wireless networks may be referred to as “base stations,” access points,” “subscriber stations,” “mobile stations,” or the like. For example, in IEEE 802.11 networks, fixed stations are typically referred to as access points (AP), and end-user devices are typically referred to as mobile stations (STA). Also for example, in IEEE 802.16 networks, fixed stations are typically referred to as base stations (BS), and end-user devices are typically referred to as subscriber stations (SS).

Network nodes in wireless networks typically communicate across the network using packets of information. As packets are assembled, they are typically put in a first-in-first-out (FIFO) queue to await transmission. The packets are then typically transmitted in the order that they were put in the queue.

### BRIEF DESCRIPTION OF THE DRAWINGS

FIG. 1 shows a diagram of a wireless network;

FIG. 2 shows a priority queue in a media access layer;

FIG. 3 shows a priority queue implementation;

FIG. 4 shows a flowchart in accordance with various embodiments of the present invention; and

FIG. 5 shows a system diagram in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

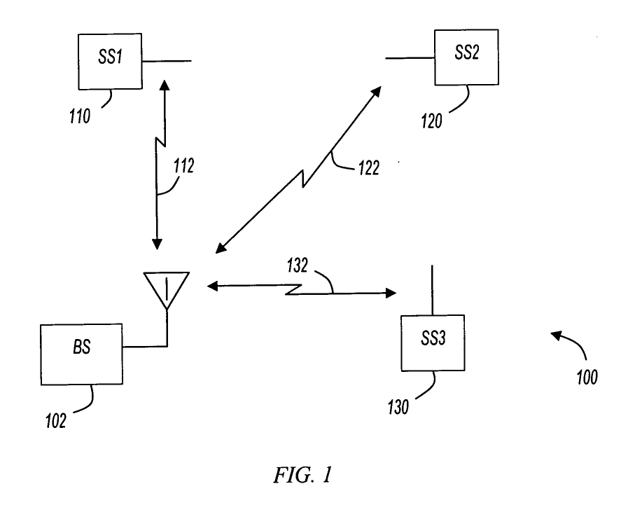

FIG. 1 shows a diagram of a wireless network. Wireless network 100 includes base station (BS) 102 and subscriber stations (SS) 110, 120, and 130. Subscriber stations 110, 120, and 130 may be any type of station capable of communicating in network 100. For example, the subscriber stations may be routers, computers, personal digital assistants, wireless-capable cellular phones, home audio or video appliances, or the like.

In some embodiments, wireless network 100 is a point to multipoint (PMP) network that provides broadband wireless access (BWA). For example, one or more of subscriber stations 110, 120, and 130, or base station 102 may operate in compliance with a wireless metropolitan area network standard such as IEEE Std. 802.16-2004, although this is not a limitation of the present invention. As used herein, the term “802.16” refers to any past, present, or future IEEE 802.16 standard, or extension thereto, including, but not limited to, the 2004 edition.

In other embodiments, wireless network 100 is a wireless local area network (WLAN). For example, one or more of subscriber stations 110, 120, and 130, or base station 102 may operate in compliance with a wireless network standard such as IEEE Std. 802.11, 1999 Edition, although this is not a limitation of the present invention. As used herein, the term “802.11” refers to any past, present, or future IEEE 802.11 standard, or extension thereto, including, but not limited to, the 1999 edition.

The remainder of this description focuses on 802.16 embodiments, although this is not a limitation of the present invention. For example, various embodiments are described in the context of packet based communications between base stations and subscriber stations in 802.16 networks. Also for example, various embodiments are described in the context of 802.16 connections and service flows.

Base station 102 communicates with subscriber station 110 (also referred to as “SS1”) using signal 112. Base station 102 communicates with subscriber station 120 (also referred to as “SS2”) using signal 122, and base station 102 communicates with subscriber station 130 (also referred to as “SS3”) using signal 132. In some embodiments, subscriber stations communicate with each other directly. For example, in some embodiments, subscriber station 110 may communicate directly with subscriber station 120 rather than communicating through base station 102. In some embodiments, signals 112, 122, and 132 are transmitted through a shared medium. For example, in some embodiments, the shared medium is the wireless channel in free space between the base station and the various subscriber stations.

Packet based communications between the various subscriber stations and base stations may have time parameters associated therewith. For example, in some embodiments, particular packets or groups of packets may have timeout values associated therewith. Timeout values may be associated with packets that are part of a handshake sequence. For example, in an 802.16 network, service flows may be added, changed, or deleted using dynamic service handshake sequences. Dynamic service handshake sequences may include dynamic service addition (DSA), dynamic service change (DSC), and dynamic service deletion (DSD) handshake sequences, collectively referred to as DSx handshake sequences. Also for example, in an 802.16 network, security may be managed using private key management (PKM) handshake sequences. DSx and PKM handshake sequences have timeout values defined in the 802.16-2004 specification.

In general, when a packet having a timeout associated therewith is transmitted, the same packet will be retransmitted if a response is not received prior to the expiration of the timeout. For example, a base station may transmit a dynamic service addition request (DSA-REQ) packet having a handshake timeout value of one second (defined at T7 in Table 342 of the 802.16-2004 specification). If a dynamic service addition response (DSA-RSP) packet is not received within one second, the DSA-REQ packet will be retransmitted. Packet retransmissions consume bandwidth that could otherwise be used for data communications.

Various embodiments of the present invention prioritize the transmission of packets having a time parameter associated therewith so as to reduce the number of retransmissions. For example, a single base station may be simultaneously processing multiple dynamic service additions, changes, and deletions for one or more subscriber stations. Each of these dynamic service modifications may be in various stages of processing, and packets having different timeout values associated therewith may be placed in a queue for transmission. In some embodiments of the present invention, the queue is a prioritized queue that has packets prioritized based on timeout values. By prioritizing packets based on timeout values, packets with shorter timeouts may be transmitted first, and retransmissions may be reduced.

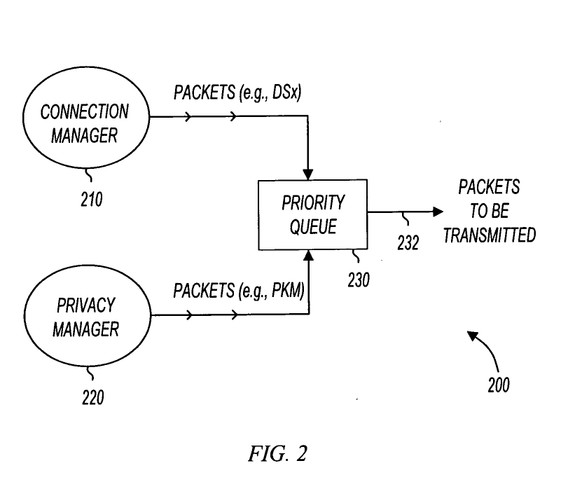

FIG. 2 shows a priority queue in a media access control (MAC) layer. Media access control layer 200 is shown having connection manager 210, privacy manager 220, and priority queue 230. Media access control layer may include many other components. The number of components shown in FIG. 2 is intentionally limited to provide clarity. Media access control layer 200 may be a media access control layer in a base station, subscriber station, or any other type of station capable of communicating wirelessly.

Priority queue 230 is shown receiving packets from connection manager 210 and privacy manager 220. Connection manager 210 may include hardware and/or software to manage connections and service flows between base stations and subscriber stations. For example, in an 802.16 context, connection manager 210 may produce dynamic service addition, change, and deletion requests, responses, and acknowledgements. Privacy manager 220 may include hardware and/or software to send and receive privacy key management (PKM) messages such as privacy key management requests (PKM-REQ) and privacy key management responses (PKM-RSP). Priority queue 230 may receive packets from other sources not shown in FIG. 2. For example, any other packets generated by media access control layer 200 may be provided to priority queue 230 for transmission.

The packets received by priority queue 230 may have time parameters associated therewith. For example, in some embodiments, the time parameters may be the time at which the packet was generated. Also for example, the time parameters may be handshake timeout values associated with the packets. The handshake timeout values may be included within the packets, or may be communicated to priority queue 230 separately from the packets.

In some embodiments, the handshake timeout values may be in the form of a time-of-expiration. For example, in some embodiments, the system may keep track of “frame numbers” where frame numbers advance at a known rate because frames last for a predetermined period of time. In these embodiments, the timeout value may be expressed as a frame number that identifies the frame in which the packet will expire.

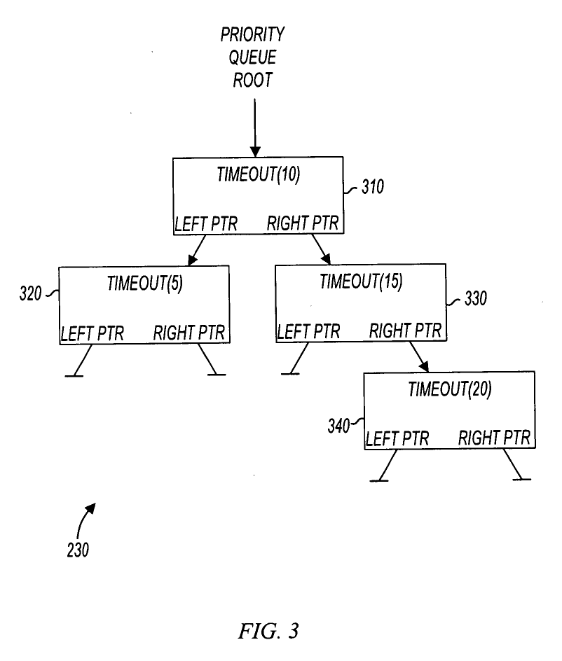

Priority queue 230 provides packets to be transmitted in priority order at 232. The priority order is determined, at least in part, on the time parameters associated with the packets. For example, the priority order may be determined based on handshake timeout values. An example data structure useful as priority queue 230 is described below with reference to FIG. 3.

FIG. 3 shows a priority queue implementation. Priority queue 230 is a binary tree data structure including nodes 310, 320, 330, and 340. Each node in the data structure corresponds to a packet having a handshake timeout (time parameter) associated therewith. For example, node 310 includes a timeout value of ten, node 320 includes a timeout value of five, node 330 includes a timeout value of fifteen, and node 340 includes a timeout value of twenty. The timeout values shown in FIG. 3 may correspond to a time-to-expiration, or a time-of-expiration. For example, the timeout value of five in node 320 may correspond to a timeout five time periods in the future, or may correspond to a timeout during frame number five.

Each node includes two pointers to point to two or less other nodes. The two pointers are shown as a “left pointer” and a “right pointer.” As packets are added to the queue, the data structure is traversed starting at the priority queue root. If the timeout value of the packet being added is less than the timeout value of the current node, the traversal continues with the left pointer. If, on the other hand, the timeout value of the packet being added is more than the timeout value of the current node, that traversal continues with the right pointer. The traversal continues until the packet to be added to the queue is added as a leaf node. As packets are transmitted, the data structure is traversed in order from the earliest timeout value to the latest timeout value.

In some embodiments, time parameters are included within packets to be transmitted. In other embodiments, time parameters are not included within packets, and are provided along with the packet to the hardware or software managing the priority queue.

The data structure shown in FIG. 3 represents one of many possible ways to implement a priority queue. The various embodiments of the present invention are not limited by the type of data structure used to implement the priority queue.

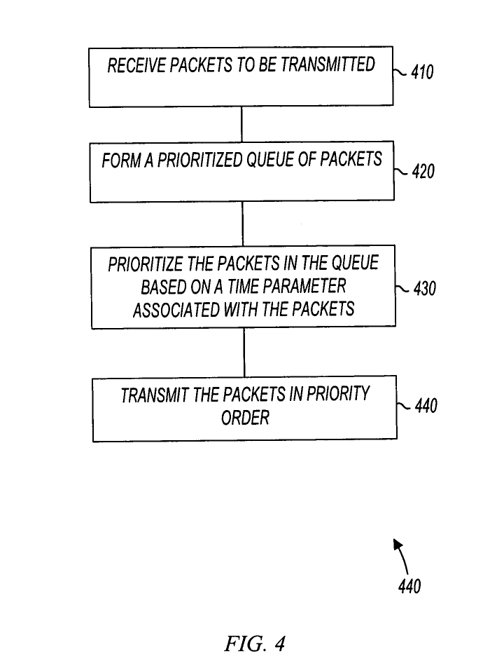

FIG. 4 shows a flowchart in accordance with various embodiments of the present invention. In some embodiments, method 400, or portions thereof, is performed by a base station, a subscriber station, an access point, a mobile station, a processor, or an electronic system, embodiments of which are shown in the various figures. Further, in some embodiments, method 400 may be performed by a media access control layer implementation or a hardware/software module that controls a priority queue. Method 400 is not limited by the particular type of apparatus, software element, or system performing the method. The various actions in method 400 may be performed in the order presented, or may be performed in a different order. Further, in some embodiments, some actions listed in FIG. 4 are omitted from method 400.

Method 400 is shown beginning at block 410 in which packets to be transmitted are received. In some embodiments, the packets to be transmitted have time parameters associated therewith. The time parameters may be included within the packet or may be passed along with the packet. In some embodiments, the time parameters correspond to handshake timeout information. For example, in an 802.16 context, packets received at 410 and prioritized at 420 may be DSx and/or PKM packets.

At 420, a prioritized queue of packets is formed. In some embodiments, this corresponds to a priority queue in an 802.16 media access control layer, such as priority queue 230 (FIG. 2). At 430, the packets are prioritized in the queue based on the time parameter associated with the packets. At 440, the packets are transmitted in priority order.

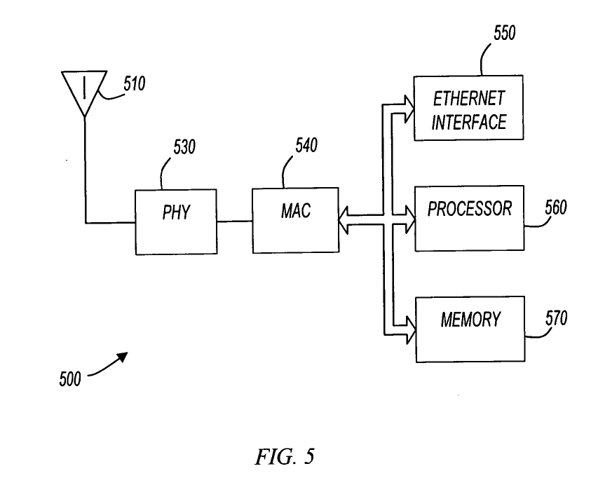

FIG. 5 shows a system diagram in accordance with various embodiments of the present invention. Electronic system 500 includes antenna 510, physical layer (PHY) 530, medium access control (MAC) mechanism 540, Ethernet interface 550, processor 560, and static random access memory (SRAM) 570. In some embodiments, electronic system 500 may be a base station or subscriber station capable of prioritizing packet communications based on time parameters associated with the packets. Further, in some embodiments, electronic system 500 may be a base station or subscriber station that prioritizes packets on an 802.16 management channel based on handshake timeout values. For example, electronic system 500 may be utilized in network 100 as base station 102, or as one of subscriber stations 110, 120, or 130. Also for example, electronic system 500 may be a base station or subscriber station capable of communicating using any of the methods described with reference to the previous figures.

In some embodiments, electronic system 500 may represent a system that includes a base station or subscriber station as well as other circuits. For example, in some embodiments, electronic system 500 may be a computer, such as a personal computer, a workstation, or the like, that includes a network interface as a peripheral or as an integrated unit. Further, electronic system 500 may include a series of base stations that are coupled together in a network.

Antenna 510 may be a directional antenna or an omni-directional antenna. As used herein, the term omni-directional antenna refers to any antenna having a substantially uniform pattern in at least one plane. For example, in some embodiments, antenna 510 may be an omni-directional antenna such as a dipole antenna, or a quarter wave antenna. Also for example, in some embodiments, antenna 510 may be a directional antenna such as a parabolic dish antenna or a Yagi antenna. In still further embodiments, antenna 510 includes multiple physical antennas. For example, in some embodiments, multiple antennas are utilized to multiple-input-multiple-output (MIMO) processing or spatial-division multiple access (SDMA) processing.

In operation, system 500 sends and receives signals using antenna 510, and the signals are processed by the various elements shown in FIG. 5. Physical layer 530 is coupled to antenna 510 to interact with a wireless network. Physical layer (PHY) 530 may be any suitable physical layer implementation. For example, PHY 530 may be a circuit block that implements a physical layer that complies with an IEEE 802.11 standard, IEEE 802.16 standard, or other standard. Examples include, but are not limited to, time division multiplexing (TDM), frequency division multiplexing (FDM), direct sequence spread spectrum (DSSS), frequency hopping spread spectrum (FHSS), and orthogonal frequency division multiplexing (OFDM). Accordingly, PHY 530 may include circuitry to support the transmission and reception of radio frequency (RF) signals. For example, in some embodiments, PHY 530 includes an RF receiver to receive signals and perform “front end” processing such as low noise amplification (LNA), filtering, frequency conversion or the like. Also for example, in some embodiments, PHY 530 may include circuits to support frequency up-conversion, and an RF transmitter. The invention is not limited by the contents or function of PHY 530.

Medium access control (MAC) mechanism 540 may be any suitable medium access control layer implementation. For example, MAC 540 may be implemented in software, or hardware, or any combination thereof. In some embodiments, a portion of MAC 540 may be implemented in hardware, and a portion may be implemented in software that is executed by processor 560. Further, MAC 540 may include a processor separate from processor 560. MAC 540 may implement any of the communications embodiments of the present invention. For example, MAC 540 may provide a prioritized queue that prioritizes packets based on time parameters associated with the packets.

Processor 560 may perform method embodiments of the present invention, such as method 400 (FIG. 4). Processor 560 represents any type of processor, including but not limited to, a microprocessor, a digital signal processor, a microcontroller, or the like.

Memory 570 represents an article that includes a machine readable medium. For example, memory 570 represents a random access memory (RAM), dynamic random access memory (DRAM), static random access memory (SRAM), read only memory (ROM), flash memory, or any other type of article that includes a medium readable by processor 560. Memory 570 may store instructions for performing the execution of the various method embodiments of the present invention. Memory 570 may also hold a prioritized queue. For example, MAC 540 may access memory 570 to store a queue of prioritized packets, where the packets are prioritized based on time parameters associated with the packets.

Ethernet interface 550 may provide communications between electronic system 500 and other systems. For example, in some embodiments, electronic system 500 may be a base station that utilizes Ethernet interface 550 to communicate with a wired network or to communicate with other base stations. Some embodiments of the present invention do not include Ethernet interface 550. For example, in some embodiments, electronic system 500 may be a network interface card (NIC) that communicates with a computer or network using a bus or other type of port.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A method comprising forming a prioritized queue of packets wherein the queue is prioritized based at least in part on handshake timeout information associated with the packets.

2. The method of claim 1 wherein the handshake timeout information is included within the packets.

3. The method of claim 1 wherein forming a prioritized queue comprises forming a queue to transmit a private key management (PKM) request.

4. The method of claim 1 wherein forming a prioritized queue comprises forming a queue to transmit a private key management (PKM) response.

5. The method of claim 1 wherein forming a prioritized queue comprises forming a queue to transmit a dynamic service (DSx) request.

6. The method of claim 1 wherein forming a prioritized queue comprises forming a queue to transmit a dynamic service (DSx) response.

7. The method of claim 1 wherein the packets are queued at a base station in preparation for transmission to a subscriber station in a wireless network.

8. The method of claim 1 wherein the packets are queued at a subscriber station in preparation for transmission to a base station in a wireless network.

9. The method of claim 1 wherein the packets are to be transmitted over an IEEE 802.16 management connection.

10. An apparatus comprising:
a media access control layer implementation for use in a communications system, the media access control layer having a prioritized queue for packets to be transmitted over a management connection, the prioritized queue being prioritized based at least in part on a time parameter associated with each of the packets.

11. The apparatus of claim 10 wherein the time parameter is expressed as a frame number.

12. The apparatus of claim 10 wherein the time parameter comprises a data value describing a time-of-expiration.

13. The apparatus of claim 12 wherein the time-of-expiration corresponds to a handshake timeout.

14. The apparatus of claim 13 wherein packets with the earliest time-of-expiration are prioritized to be transmitted first.

15. The apparatus of claim 10 wherein the media access control layer implementation is at least partially IEEE 802.16 compliant.

16. An electronic system comprising:
a physical layer implementation to transmit a plurality of packets over a management connection;
a processor coupled to the physical layer; and
a static random access memory having a prioritized queue with the plurality of packets therein, the prioritized queue being prioritized based at least in part on a time parameter associated with each of the plurality of packets.

17. The electronic system of claim 16 wherein the time parameter is expressed as a frame number.

18. The electronic system of claim 16 wherein the prioritized queue is prioritized based on a time-of-expiration for each of the plurality of packets.

19. The electronic system of claim 18 wherein the time-of-expiration corresponds to a handshake timeout.

20. The electronic system of claim 16 wherein the electronic system is substantially IEEE 802.16 compliant.
